(19) United States
(12) Patent Application Publication
(10) Pub. No.: US 2026/0268438 A1
(43) Pub. Date: Sep. 10, 2026

(54) METHODS, SYSTEMS, AND APPARATUSES FOR FRAME INTERPOLATION AND CONTENT DISTRIBUTION

(71) Applicant: Comcast Cable Communications, LLC, Philadelphia, PA (US)

(72) Inventors: Matthew R. Ebersviller, Centennial, CO (US); Ryan L. McMurray, Centennial, CO (US); Jonathan Kirkovich, Centennial, CO (US)

(21) Appl. No.: 19/073,138

(22) Filed: Mar. 7, 2025

(51) Int. Cl. G06T 3/4007; G06T 7/00

(52) U.S. Cl. CPC G06T 3/4007; G06T 7/0002; G06T 2207/30168

(57) ABSTRACT

Described herein are methods, systems, and apparatuses for frame interpolation and content distribution. Sharpness metrics of frame edges in content may be analyzed to identify interpolated frames. Upon detecting interpolated frames, they may be removed. In some examples, replacement frames may be generated using an improved interpolation method. The replacement frames may be output as part of the content. In some aspects, a user device, such as a client device, may request content from a computing device, such as a server or content cache. The user device may generate its own replacement interpolated frames, or it may receive the content with replacement interpolated frames. Other examples are possible as well.

### BACKGROUND

Frame rate conversion techniques aim to increase the perceived smoothness of video content by generating additional frames between existing ones. This process involves analyzing motion between successive frames and interpolating new frames to fill temporal gaps. While frame rate conversion may enhance visual quality, particularly for high-motion content, it may introduce artifacts in certain scenarios. These artifacts may manifest as blurring, ghosting, or unnatural motion, potentially impacting the viewing experience. As display technologies advance and content delivery methods evolve, there is ongoing interest in refining frame rate conversion algorithms to minimize artifacts and optimize performance across diverse video content types. Balancing the benefits of increased frame rates with the preservation of original image quality remains an area of active research and development in video processing. These and other considerations are discussed herein.

### SUMMARY

It is to be understood that both the following general description and the following detailed description are exemplary and explanatory only and are not restrictive. This summary is not intended to identify critical or essential features, but merely to summarize certain features and variations. Other details and features will be described in the sections that follow.

Described herein are methods, systems, and apparatuses for frame interpolation and content distribution. In some examples, the present methods, systems, and apparatuses may be used for detecting and replacing interpolated frames in content (e.g., video content). Sharpness metrics of frame edges in content may be analyzed to identify interpolated frames. For example, interpolated frames may be identified when sharpness metric values are significantly different as compared to neighboring frames. Additionally, or in the alternative, interpolated frames may be identified when sharpness metric values are associated with a bimodal distribution. Other examples are possible as well.

Upon detecting interpolated frames, they may be removed and, in some cases, replacement frames may be generated using an improved interpolation method. The replacement frames may be output as part of the content. For example, a user device, such as a client device, may request content from a computing device, such as a server or content cache. The user device may receive the content excluding any identified/detected interpolated frames (e.g., based on a corresponding request for the content), or the user device may detect/identify, and subsequently remove, the interpolated frames. The user device may generate its own replacement interpolated frames, or it may receive the content with replacement interpolated frames. Other examples are possible as well.

### BRIEF DESCRIPTION OF THE DRAWINGS

The accompanying drawings, which are incorporated in and constitute a part of this specification, together with the description, serve to explain the principles of the present methods, systems, and apparatuses:

FIG. 1 shows an example system;

FIG. 2A shows a first example video frame;

FIG. 2B shows a second example video frame;

FIG. 3A shows a first example graph;

FIG. 3B shows a second example graph;

FIG. 4 shows an example system;

FIG. 5 shows a flowchart for an example method;

FIG. 6 shows a flowchart for an example method; and

FIG. 7 shows a flowchart for an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint. “Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions. “Content items,” as the phrase is used herein, may also be referred to as “content,” “content data,” “content information,” “content asset,” “multimedia asset data file,” or simply “data” or “information”. Content items may be any information or data that may be licensed to one or more individuals (or other entities, such as business or group). Content may be electronic representations of video, audio, text, and/or graphics, which may be but is not limited to electronic representations of videos, movies, or other multimedia, which may be but is not limited to data files adhering to H.264/MPEG-AVC, H.265/MPEG-HEVC, H.266/MPEG-VVC, MPEG-5 EVC, MPEG-5 LCEVC, AV1, MPEG2, MPEG, MPEG4 UHD, SDR, HDR, 4k, Adobe® Flash® Video (.FLV), ITU-T H.261, ITU-T H.262 (MPEG-2 video), ITU-T H.263, ITU-T H.264 (MPEG-4 AVC), ITU-T H.265 (MPEG HEVC), ITU-T H.266 (MPEG VVC) or some other video file format, whether such format is presently known or developed in the future. The content items described herein may be electronic representations of music, spoken words, or other audio, which may be but is not limited to data files adhering to MPEG-1 audio, MPEG-2 audio, MPEG-2 and MPEG-4 advanced audio coding, MPEG-H, AC-3 (Dolby Digital), E-AC-3 (Dolby Digital Plus), AC-4, Dolby Atmos®, DTS®, and/or any other format configured to store electronic audio, whether such format is presently known or developed in the future. Content items may be any combination of the above-described formats. “Consuming content” or the “consumption of content,” as those phrases are used herein, may also be referred to as “accessing” content, “providing” content, “viewing” content, “listening” to content, “rendering” content, or “playing” content, among other things. In some cases, the particular term utilized may be dependent on the context in which it is used. Consuming video may also be referred to as viewing or playing the video. Consuming audio may also be referred to as listening to or playing the audio. This detailed description may refer to a given entity performing some action. It should be understood that this language may in some cases mean that a system (e.g., a computer) owned and/or controlled by the given entity is actually performing the action.

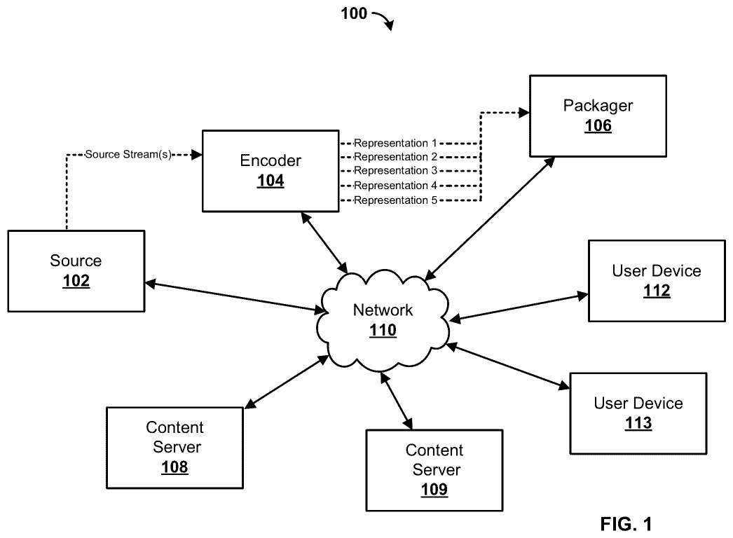

FIG. 1 shows an example system 100 that may be used for implementing various aspects of frame interpolation and content distribution. Frame interpolation is a technique used in video processing to increase the perceived smoothness of motion by generating additional frames between existing ones. This process may involve analyzing the movement of objects or pixels between consecutive frames and creating intermediate frames that represent the estimated positions of these elements at points in time between the original frames. The goal of frame interpolation is often to increase the frame rate of video content, which may result in smoother playback, reduced motion blur, and an overall enhanced viewing experience. In the context of content distribution and playback in/via the system 100, frame interpolation may be applied at various stages of the pipeline. Frame interpolation may be implemented during content creation, as part of post-processing, or even in real-time at user devices as further discussed herein.

While frame interpolation may potentially improve the visual quality of video content, particularly for fast-moving scenes or sports broadcasts, frame interpolation may also introduce certain artifacts or undesirable effects. These artifacts may include blurring, ghosting, or unnatural motion that may detract from the viewing experience. The severity and nature of these artifacts may depend on factors such as the complexity of the scene, the speed of motion, and the sophistication of the interpolation algorithm used. One challenge in frame interpolation is accurately estimating motion between frames, especially in scenes with complex movements, multiple objects, or rapid changes in lighting or perspective. The system 100 may employ advanced interpolation techniques/methods to improve the quality of generated frames as further discussed herein. Additionally, in scenarios where multiple stages of processing or distribution may have applied frame interpolation, detecting and potentially removing or replacing interpolated frames may help maintain content integrity and avoid compounding artifacts associated with interpolation.

The system 100 may consider sharpness metrics associated with frames when detecting/identifying interpolated frames. Because interpolated frames are generated based on estimations and may not contain the same level of detail or edge definition as original frames, interpolated frames may exhibit different sharpness characteristics. By analyzing the sharpness of frame edges and comparing these metrics across neighboring (e.g., consecutive) frames, the system 100 may identify sharpness patterns or anomalies that indicate the presence of interpolated content as further described herein.

The system 100 may comprise a variety of interconnected components that work together to process, distribute, and potentially modify video content, including handling interpolated frames. The system 100 may comprise a plurality of computing devices/entities in communication via a network 110. The network 110 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent on the network 110 via a variety of transmission paths, including wireless paths (e.g., satellite paths, Wi-Fi paths, cellular paths, etc.) and terrestrial paths (e.g., wired paths, a direct feed source via a direct line, etc.). The network 110 may comprise public networks, private networks, wide area networks (e.g., Internet), local area networks, and/or the like. The network 110 may comprise a content access network, content distribution network, and/or the like. The network 110 may be configured to provide content from a variety of sources using a variety of network paths, protocols, devices, and/or the like. The content delivery network and/or content access network may be managed (e.g., deployed, serviced) by a content provider, a service provider, and/or the like. The network 110 may deliver content items from a source(s) to a user device(s).

The system 100 may comprise a source 102, such as a server or other computing device. The source 102 may receive source streams for a plurality of content items. The source streams may be live streams (e.g., a linear content stream) and/or video-on-demand (VOD) streams. The live streams may comprise, for example, low-latency (“LL”) live streams. The source 102 may receive the source streams from an external server or device (e.g., a stream capture source, a data storage device, a media server, etc.). The source 102 may receive the source streams via a wired or wireless network connection, such as the network 110 or another network (not shown).

The source 102 may comprise a headend, a video-on-demand server, a cable modem termination system, and/or the like. The source 102 may provide content (e.g., video, audio, games, applications, data) and/or content items (e.g., video, streaming content, movies, shows/programs, etc.) to user devices. The source 102 may provide streaming media, such as live content, on-demand content (e.g., video-on-demand), content recordings, and/or the like. The source 102 may be managed by third-party content providers, service providers, online content providers, over-the-top content providers, and/or the like. A content item may be provided via a subscription, by individual item purchase or rental, and/or the like. The source 102 may be configured to provide content items via the network 110. Content items may be accessed by user devices via applications, such as mobile applications, television applications, set-top box applications, gaming device applications, and/or the like. An application may be a custom application (e.g., by a content provider, for a specific device), a general content browser (e.g., a web browser), an electronic program guide, and/or the like. The source 102 may provide uncompressed content items, such as raw video data, comprising one or more portions (e.g., frames/slices, groups of pictures (GOP), coding units (CU), coding tree units (CTU), etc.). It should be noted that although a single source 102 is shown in FIG. 1, this is not to be considered limiting. In accordance with the described techniques, the system 100 may comprise a plurality of sources 102, each of which may receive any number of source streams.

The system 100 may comprise an encoder 104, such as a video encoder, a content encoder, etc. The encoder 104 may be configured to encode one or more source streams received via the source 102 into a plurality of content items/streams at various bitrates (e.g., various representations/quality levels). For example, the encoder 104 may be configured to encode a source stream for a content item at varying bitrates for corresponding representations (e.g., versions/quality levels) of a content item for adaptive bitrate streaming.

As shown in FIG. 1, the encoder 104 may encode a source stream into Representations 1-5. It is to be understood that the FIG. 1 shows five representations for explanation purposes only. The encoder 104 may be configured to encode a source stream into fewer or greater representations. Representation 1 may be associated with a first resolution (e.g., 480p) and/or a first bitrate (e.g., 2 Mbps). Representation 2 may be associated with a second resolution (e.g., 720p) and/or a second bitrate (e.g., 3.5 Mbps). Representation 3 may be associated with a third resolution (e.g., 1080p) and/or a third bitrate (e.g., 6 Mbps). Representation 4 may be associated with a fourth resolution (e.g., 4K) and/or a first bitrate (e.g., 18 Mbps). Representation 5 may be associated with a fifth resolution (e.g., 8K) and/or a fifth bitrate (e.g., 45 Mbps). Other example resolutions and/or bitrates are possible. Note that “Representation” is a term defined for MPEG DASH (ISO/IEC 23009-1), while Apple HTTP Live Streaming (IETF RFC 8216) (hereinafter, “HLS”) defines the same concept as a “variant,” and the present methods, systems, and apparatuses are not intended to be limited to DASH-based environments/use cases.

The system 100 may comprise a packager 106. The packager 106 may be configured to receive one or more content items/streams from the encoder 104. The packager 106 may be configured to prepare content items/streams for distribution. For example, the packager 106 may be configured to convert encoded content items/streams into a plurality of content fragments. The packager 106 may be configured to provide content items/streams according to adaptive bitrate streaming. For example, the packager 106 may be configured to convert encoded content items/streams at various representations into one or more adaptive bitrate streaming formats, such as Apple HTTP Live Streaming (HLS), Microsoft Smooth Streaming, Adobe HTTP Dynamic Streaming (HDS), MPEG DASH, any media streaming format based on the TCP or reliable UDP (e.g., Quick UDP Internet Connections, “QUIC”) transport protocol, driven by client requests, and/or the like.

The packager 106 may pre-package content items/streams and/or provide packaging in real-time as content items/streams are requested by user devices, such as a user device 112 and a user device 113. The user devices 112 and 113 may each be a content/media player, a set-top box, a client device, a smart device, a mobile device, a user device, etc. Though only two user devices are shown in FIG. 1, it is to be understood that the system 100 may comprise fewer or greater user devices. For ease of explanation, the description herein will use the user device 112 for most examples. However, it is to be understood that any description of functionality or steps taken or performed by the user device 112 may apply equally to the user device 113 and vice-versa.

The system 100 may comprise a content server 108. The content server 108 may be configured to receive requests for content, such as content items/streams. The content server 108 may identify a location of a requested content item and provide the content item- or a portion thereof-to a device requesting the content, such as the user device 112 and/or the user device 113. The content server 108 may be configured to provide a communication session with a requesting device, such as the user device 112, based on HTTP, FTP, or other protocols. The content server 108 may be one of a plurality of content servers distributed across the system 100. The content server 108 may be located in a region proximate to the user device 112.

A request for a content stream/item from the user device 112 may be directed to the content server 108 (e.g., due to the location and/or network conditions). The content server 108 may be configured to deliver content streams/items to the user device 112 in a specific format requested by the user device 112. The content server 108 may be configured to provide the user device 112 with a manifest file (e.g., or other index file describing portions of the content) corresponding to a content stream/item. The content server 108 may be configured to provide streaming content (e.g., unicast, multicast) to the user device 112. The content server 108 may be configured to provide a file transfer and/or the like to the user device 112. The content server 108 may cache or otherwise store content (e.g., frequently requested content) to enable faster delivery of content items to users. The content server 108 may receive a request for a content item, such as a request for high-resolution video and/or the like. The content server 108 may receive the request for the content item from the user device 112. As further described herein, the content server 108 may be capable of sending (e.g., to the user device 112) one or more portions of the content item at varying bitrates (e.g., Representations 1-5).

The system 100 may comprise a content server 109 that provides similar functionality as the content server 108. The content server 109 may be “upstream” with respect to the content server 108 and/or the user devices 112,113. For example, the content server 109 may be “closer” in terms of network hops to an origin/source of the content relative to the content server 108. Additionally, or in the alternative, the content server 109 may comprise- or be a part of-a content origin(s), a mezzanine feed(s), etc. Though only two content servers are shown in FIG. 1, it is to be understood that the system 100 may comprise fewer or greater content servers. For ease of explanation, the description herein will use the content server 108 for most examples. However, it is to be understood that any description of functionality or steps taken or performed by the content server 108 may apply equally to the content server 109 and vice-versa.

The system 100 may be configured to detect and analyze interpolated frames within content using various methods. For example, each of the content server 108, the content server 109, the user device 112, and the user device 113 may analyze content to detect interpolated frames and -optionally-generate replacement interpolated frames. One method for detecting interpolated frames, as further described herein, may involve identifying and/or analyzing a sawtooth pattern in a plot of sharpness metrics for corresponding (e.g., neighboring) frames of the content. For example, the content server 108 may generate a sharpness metric for each frame of a plurality of frames in a content item. The content server 108 may plot these sharpness metrics against the frame number or time. In some cases, as further described herein, a sawtooth pattern may emerge in this plot, where alternating frames show higher and lower sharpness values. This pattern may indicate the presence of interpolated frames, as the interpolated frames may have lower sharpness values compared to the original frames.

For example, the content server 108 may analyze the edge sharpness of objects within each frame. The content server 108 may calculate a sharpness value based on the contrast between adjacent pixels along object edges. In some cases, interpolated frames may show less distinct edges due to the interpolation process, resulting in lower sharpness values. When plotted, these alternating high and low sharpness values may create a characteristic sawtooth pattern as further described herein.

Another method for detecting interpolated frames may involve identifying a bimodal distribution of sharpness metrics across the plurality of frames. For example, the user device 112 may analyze the distribution of sharpness metrics for all frames in a content item. In some cases, the user device 112 may detect two distinct clusters of sharpness values-one cluster with higher values corresponding to original frames, and another cluster with lower values corresponding to interpolated frames. For instance, the user device 112 may compute a histogram of sharpness values for all frames. And the user device 112 may then analyze this histogram for the presence of two distinct peaks. In some cases, if two clear peaks are present, this may indicate a bimodal distribution and suggest the presence of interpolated frames further described herein.

The system 100 may apply different interpolation methods based on user preferences or device capabilities. For example, the content server 109 may detect interpolated frames using one of the aforementioned methods and remove them before delivering content to the user device 113. The user device 113 may then apply a new interpolation method. Additionally, or in the alternative, the content server 109 may apply a new interpolation method. Regardless of the device(s) used, replacement interpolated frames may be generated based on a variety of factors, such as the user device's 113 capabilities, a user preference(s), content type, etc. For instance, while sports content may benefit from increased frame rates, cinematic content may be intentionally presented at lower frame rates to preserve a specific aesthetic or creative intent. Other examples are possible as well.

In some cases, the system 100 may use edge computing to perform frame interpolation detection and/or replacement closer to the end user. For example, the content server 109 may be “closer” in terms of network hops to the user device 112 relative to the content server 108, and the content server 109 may perform the detection and replacement of interpolated frames, reducing latency and bandwidth usage in some cases. In other examples, the system 100 may integrate interpolation detection/replacement with artificial intelligence (AI) and/or machine learning (ML) techniques to generate replacement frames. In some cases, the packager 106 may prepare multiple versions of content—one with original interpolated frames and another with replaced interpolated frames (or no interpolated frames). The network 110 may then deliver the appropriate version based on content type, device capabilities, corresponding user request, user preference(s), etc.

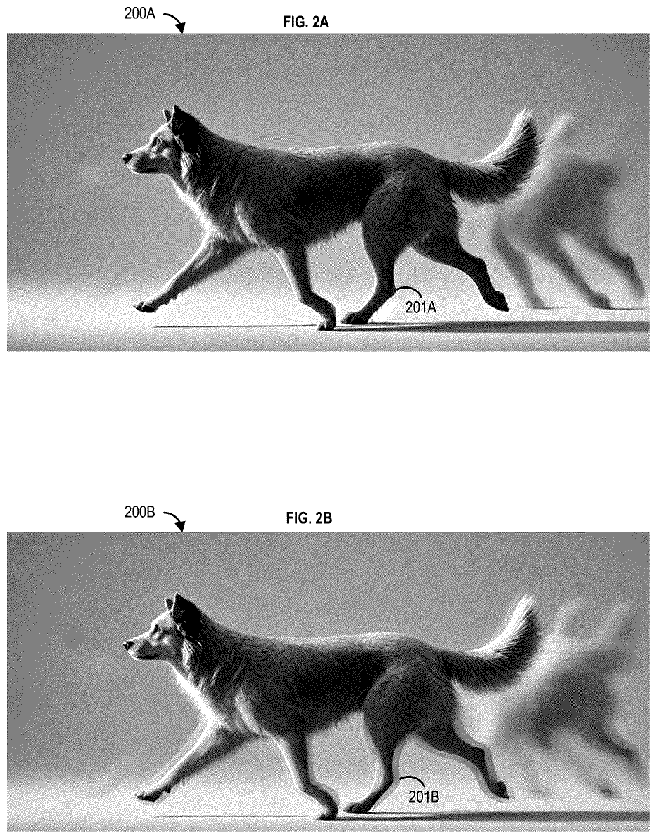

Turning now to FIGS. 2A and 2B, a comparison between an original video frame and an interpolated video frame is shown. FIG. 2A shows a video frame 200A. The video frame 200A may comprise one or more objects, and the one or more objects may comprise one or more edges. As shown in FIG. 2A, a frame edge 201A may be associated with the one or more edges of the one or more objects in the video frame 200A. The frame edge 201A may demonstrate sharp, well-defined contours along the outline and features of the one or more objects (e.g., because the frame is a non-interpolated frame).

FIG. 2B depicts an interpolated video frame 200B. The interpolated video frame 200B may comprise the same one or more objects as the video frame 200A. However, an interpolated frame edge 201B may be associated with the one or more edges of the one or more objects in the interpolated video frame 200B. The interpolated frame edge 201B may exhibit less distinct contours and reduced sharpness compared to the frame edge 201A of the video frame 200A (e.g., because the frame is an interpolated frame). The video frame 200A and the interpolated video frame 200B may demonstrate visual differences between original and interpolated frames, particularly in terms of edge sharpness and detail preservation. The interpolated frame edge 201B may show characteristics typical of interpolated frames (e.g., computer-generated intermediate frames), while the frame edge 201A may represent the natural sharpness of directly-captured video content.

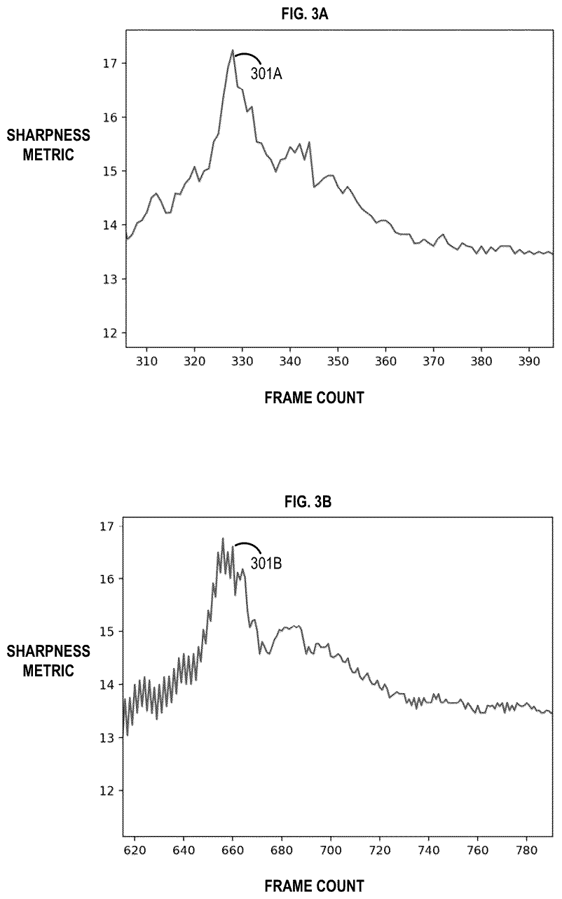

FIGS. 3A and 3B illustrate plots of sharpness metrics for frames of video content. For example, the plot of sharpness metrics for frames of video content in FIG. 3A may correspond to a plurality of frames that includes the video frame 200A, while the plot of sharpness metrics for frames of video content in FIG. 3B may correspond to a plurality of frames that includes the interpolated video frame 200B. As can be seen, FIG. 3A shows a normal sharpness plot 301A. The normal sharpness plot 301A may display a relatively smooth curve with a single peak, for example. As mentioned, the normal sharpness plot 301A may correspond to an actual video frame, such as the video frame 200A.

By contrast, FIG. 3B shows a sawtooth sharpness plot 301B. The sawtooth sharpness plot 301B may exhibit a characteristic zigzag pattern with regular fluctuations in the sharpness values of frames as time/frame count increases. The sawtooth sharpness plot 301B may exhibit more frequent variations in the sharpness metric compared to the normal sharpness plot 301A, indicating the presence of interpolated frames in the content. For example, the sawtooth sharpness plot 301B may correspond to a plurality of frames that includes the interpolated video frame 200B.

As described herein, any of the content servers 108, 109 or the user devices 112, 113 may analyze content to detect interpolated frames and -optionally-generate replacement interpolated frames. In one example, the content server 108 may analyze content to detect interpolated frames by identifying/analyzing a sawtooth pattern in a plot of sharpness metrics. For example, the content server 108 may generate a sharpness metric for each frame of a plurality of frames in a content item. The content server 108 may plot these sharpness metrics against the frame count, as illustrated in FIG. 3A-3B. While FIG. 3A shows a normal sharpness plot 301A with a relatively smooth curve, FIG. 3B displays a sawtooth sharpness plot 301B with a characteristic zigzag pattern. This sawtooth pattern, where alternating frames show higher and lower sharpness values, may indicate the presence of interpolated frames.

In another example, the user device 112 may analyze content to detect interpolated frames based on a bimodal distribution of sharpness metrics. The user device 112 may analyze the distribution of sharpness metrics for all frames in a content item. Referring to FIG. 2A and FIG. 2B, the user device 112 may compute sharpness values based on the contrast between adjacent pixels along object edges, such as the frame edge 201A and the interpolated frame edge 201B. The user device 112 may compute/determine/generate a histogram of the sharpness values, and the user device 112 may then determine two distinct clusters of sharpness values in the histogram-one cluster with higher values corresponding to original frames like the video frame 200A, and another cluster with lower values corresponding to interpolated frames like the interpolated video frame 200B. The two clear peaks being present in the histogram may indicate a bimodal distribution of the sharpness metrics and therefore suggest the presence of interpolated frames.

In any of the described examples herein, upon identifying/detecting interpolated frames, the corresponding device (e.g., the content server 108, the user device 112, etc.) may optionally generate replacement interpolated frames (e.g., using an improved interpolation method(s)). Such replacement interpolated frames may be inserted into the content prior to delivery and/or output. Alternatively, the content may be provided without interpolated frames, and the user device 112 or 113 may receive the content and generate replacement interpolated frames at the client side. Examples of interpolation methods that may be used by the system 100 include motion-compensated frame interpolation; deep learning-based methods; phase-based frame interpolation; adaptive interpolation; super-resolution interpolation; a combination thereof; and/or the like. Other examples are possible as well. The choice of interpolation method may depend on factors such as computational resources, desired output quality, specific characteristics of the video content, etc.

Additionally, or in the alternative, the content may be delivered and/or output without the detected/identified interpolated frames and/or with an indication of which frames are interpolated. By providing an indication of which frames are interpolated, the system 100 may prevent interpolated frames from skewing bandwidth estimates, causing unnecessary quality fluctuations, etc. For example, an indication of which frames are interpolated may allow the corresponding device(s) to properly consider interpolated frames when making adaptive bitrate decisions and/or when determining service metrics or quality scores, such as service metric calculations or Quality of Experience (QoE) scores.

The indication of which frames are interpolated may, in some examples, cause the user device 112 and/or the content server 108 to exclude interpolated frames from service metrics, quality scores, and/or other calculations and analyses in order to get a more accurate representation of true video quality, bandwidth, throughput, etc. For adaptive bitrate streaming, the indication may allow the user device 112 and/or the content server 108 to focus on the original frames when determining network conditions and selecting the appropriate bitrate. Service metrics like buffering ratio, startup time, and/or playback smoothness may be computed using only the original frames, as additional examples. By excluding interpolated frames from these decisions and calculations, the system 100 may obtain more reliable data about actual video performance and user experience. This may allow for better optimization of content delivery, more accurate reporting of streaming quality, and improved decision-making for future content encoding and distribution strategies.

As described herein, any of the content servers 108, 109 or the user devices 112, 113 may be capable of analyzing frame edges within frames of content to detect interpolated frames. For example, any of the content servers 108, 109 or the user devices 112, 113 may identify/detect frame edges based on pixel intensity (e.g., using a segmentation algorithm). Pixel intensity may refer to an amount of brightness and/or a color value of one or more pixels of a frame, relative to one or more neighboring pixels. As a first example, a first frame (e.g., video frame 200A) may comprise one or more pixels having a high contrast in pixel intensity (e.g., amount of brightness and/or a color value) relative to one or more neighboring pixels. This may indicate an edge/object, such as the frame edge 201A, adjacent a contrasting background (e.g., the one or more neighboring pixels).

Any of the content servers 108, 109 or the user devices 112, 113 may determine that one or more frames of content comprise one or more interpolated frames using a sharpness metric(s) and a sharpness threshold. For example, one or more frames of a plurality of frames may be analyzed and assigned individual sharpness scores. Sharpness scores for each frame may be determined using any available method(s) or practice(s). A first sharpness metric may be determined based on an average of the sharpness scores, or similar, for the one or more frames. An individual sharpness score may be determined for one or more neighboring frames of the plurality of frames as well. A second sharpness metric may be determined based on an average of the sharpness scores, or similar, for the one or more neighboring frames.

Any of the content servers 108, 109 or the user devices 112, 113 may determine that the one or more frames comprise one or more interpolated frames by comparing a difference between the first sharpness metric and the second sharpness metric to the sharpness threshold. For example, the sharpness threshold may comprise a numerical value, and the difference between the first sharpness metric and the second sharpness metric may satisfy the sharpness threshold when the difference comprises a numerical value that is equal to or less than the sharpness threshold. When the sharpness threshold is satisfied (e.g., when the first sharpness metric differs from the second sharpness metric by as much as, or more than, the sharpness threshold value), the one or more frames may be determined to be one or more interpolated frames. On the other hand, when the sharpness threshold is not satisfied (e.g., when the first sharpness metric differs from the second sharpness metric by less than the sharpness threshold value), the one or more frames may not be determined to be one or more interpolated frames. Other examples are possible as well.

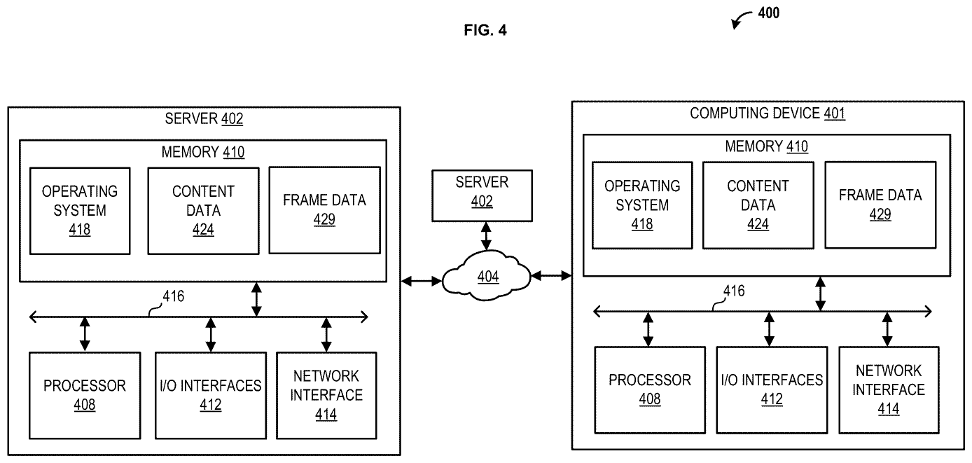

As discussed above, the present methods, systems, and apparatuses may be computer-implemented. FIG. 4 shows a block diagram depicting a system/environment 400 comprising non-limiting examples of a computing device 401 and a server 402 connected through a network 404. Either of the computing device 401 or the server 402 may be a computing device, such as any of the devices of the system 100 shown in FIG. 1. In an aspect, some or all steps of any described method may be performed on a computing device as described herein. The computing device 401 may comprise one or multiple computers configured to store frame data 429 (e.g., relating to interpolated frames, interpolation methods, etc.). The server 402 may comprise one or multiple computers configured to store content data 424 (e.g., a plurality of content segments, parameters, etc.). Multiple servers 402 may communicate with the computing device 401 via the through the network 404.

The computing device 401 and the server 402 may each be a digital computer that, in terms of hardware architecture, generally includes a processor 408, system memory 410, input/output (I/O) interfaces 412, and network interfaces 414. These components (408, 410, 412, and 414) are communicatively coupled via a local interface 416. The local interface 416 may be, for example, but not limited to, one or more buses or other wired or wireless connections, as is known in the art. The local interface 416 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 408 may be a hardware device for executing software, particularly that stored in system memory 410. The processor 408 may be any custom made or commercially available processor, a central processing unit (CPU), an auxiliary processor among several processors associated with the computing device 401 and the server 402, a semiconductor-based microprocessor (in the form of a microchip or chip set), or generally any device for executing software instructions. When the computing device 401 and/or the server 402 is in operation, the processor 408 may execute software stored within the system memory 410, to communicate data to and from the system memory 410, and to generally control operations of the computing device 401 and the server 402 pursuant to the software.

The I/O interfaces 412 may be used to receive user input from, and/or for providing system output to, one or more devices or components. User input may be provided via, for example, a keyboard and/or a mouse. System output may be provided via a display device and a printer (not shown). I/O interfaces 412 may include, for example, a serial port, a parallel port, a Small Computer System Interface (SCSI), an infrared (IR) interface, a radio frequency (RF) interface, and/or a universal serial bus (USB) interface.

The network interface 414 may be used to transmit and receive from the computing device 401 and/or the server 402 on the network 404. The network interface 414 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 414 may include address, control, and/or data connections to enable appropriate communications on the network 404.

The system memory 410 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 410 may incorporate electronic, magnetic, optical, and/or other types of storage media. Note that the system memory 410 may have a distributed architecture, where various components are situated remote from one another, but may be accessed by the processor 408.

The software in system memory 410 may include one or more software programs, each of which comprises an ordered listing of executable instructions for implementing logical functions. In the example of FIG. 4, the software in the system memory 410 of the computing device 401 may comprise the frame data 429, the content data 424, and a suitable operating system (O/S) 418. In the example of FIG. 4, the software in the system memory 410 of the server 402 may comprise the frame data 429, the content data 424, and a suitable operating system (O/S) 418. The operating system 418 essentially controls the execution of other computer programs and provides scheduling, input-output control, file and data management, memory management, and communication control and related services.

For purposes of illustration, application programs and other executable program components such as the operating system 418 are shown herein as discrete blocks, although it is recognized that such programs and components may reside at various times in different storage components of the computing device 401 and/or the server 402. An implementation of the system/environment 400 may be stored on or transmitted across some form of computer readable media.

Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

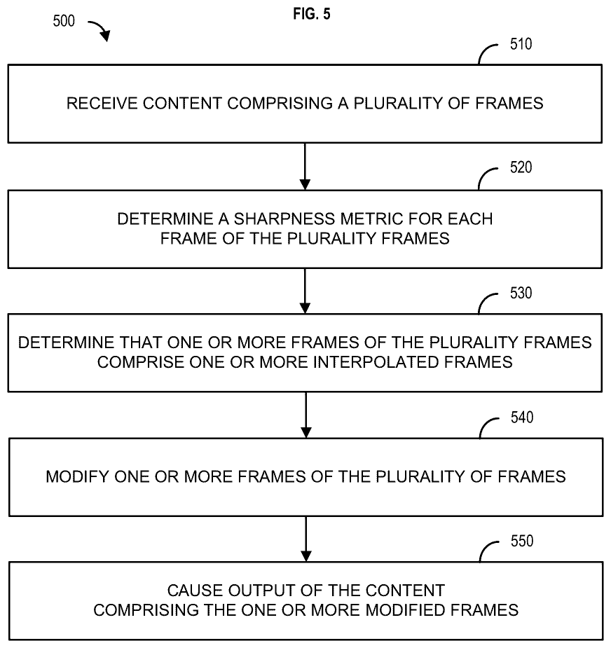

FIG. 5 shows a flowchart of an example method 500. The method 500 may be performed in whole or in part by a single computing device, a plurality of computing devices, and the like. For example, the steps of the method 500 may be performed by the content server 108, the content server 109, and/or a computing device in communication with the content server 108 or the content server 109. Some steps of the method 500 may be performed by a first computing device (e.g., the content server 108), while other steps of the method 500 may be performed by another computing device. For ease of explanation, the method 500 will be described as being performed by the content server 108.

At step 510, the content server 108 may receive content comprising a plurality of frames. Each frame of the plurality of frames may comprise one or more edges. At step 520, the content server 108 may determine a sharpness metric for each frame of the plurality of frames. The sharpness metric may be associated with the one or more edges of each frame. For example, referring to FIG. 2A-2B, the content server 108 may analyze a video frame 200A and an interpolated video frame 200B. The video frame 200A may comprise a frame edge 201A, while the interpolated video frame 200B may comprise an interpolated frame edge 201B. The content server 108 may determine the sharpness metric for each frame of the plurality of frames based on the characteristics of the frame edge 201A and the interpolated frame edge 201B.

At step 530, the content server 108 may determine that the one or more frames comprise one or more interpolated frames. For example, the content server 108 may determine that the one or more frames comprise the one or more interpolated frames based on a first sharpness metric and a second sharpness metric. The first sharpness metric may be associated with the one or more frames, and the second sharpness metric may be associated with one or more neighboring frames of the plurality of frames. For example, the content server 108 may determine that the one or more frames comprise the one or more interpolated frames by comparing a difference between the first sharpness metric and the second sharpness metric to a sharpness threshold.

The sharpness threshold may comprise a numerical value, and the difference between the first sharpness metric and the second sharpness metric may satisfy the sharpness threshold when the difference comprises a numerical value that is equal to or less than the sharpness threshold. When the sharpness threshold is satisfied (e.g., when the first sharpness metric differs from the second sharpness metric by as much as, or more than, the sharpness threshold value), the content server 108 may the determine that the one or more frames comprise the one or more interpolated frames. On the other hand, when the sharpness threshold is not satisfied (e.g., when the first sharpness metric differs from the second sharpness metric by less than the sharpness threshold value), the content server 108 may the determine that the one or more frames are not interpolated frames. Other examples are possible as well.

In some cases, a first subset of the plurality of frames may be associated with a first range of sharpness metrics, and a second subset of the plurality of frames may be associated with a second range of sharpness metrics. The content server 108 may determine that the first subset of the plurality of frames comprises the one or more interpolated frames based on the first range of sharpness metrics and the second range of sharpness metrics. For example, the first range of sharpness metrics and the second range of sharpness metrics may be indicative of a bimodal distribution of frame sharpness across the plurality of frames, and the first range of sharpness metrics may substantially differ from the second range of sharpness metrics.

At step 540, the content server 108 may modify one or more frames of the plurality of frames. For example, the content server 108 may modify the one or more frames based on (e.g., in response to) the one or more frames comprising the one or more interpolated frames. The content server 108 may modify the one or more frames by generating one or more replacement interpolated frames (e.g., to replace the one or more interpolated frames). In some cases, the one or more interpolated frames may be associated with a first interpolation method, and the content server 108 may generate the one or more replacement interpolated frames using a second interpolation method. In some cases, the second interpolation method may be associated with a user preference or a user device, such as the user device 112 or 113 of the system 100. For example, the content server 108 may select the second interpolation method based on preferences specified by a user or capabilities of the user device receiving the content.

At step 550, the content server 108 may cause output of the content comprising the one or more modified frames. For example, the content server 108 may cause output of the content comprising the one or more replacement interpolated frames. In some cases, the content server 108 may receive a request for the content from a user device, such as the user device 112 or 113 of the system 100. The content server 108 may receive the request and send the content to the user device excluding the one or more interpolated frames. The user device may then generate the one or more replacement interpolated frames using the second interpolation method. The user device may cause output of the plurality of frames comprising the one or more replacement interpolated frames. Other examples are possible as well.

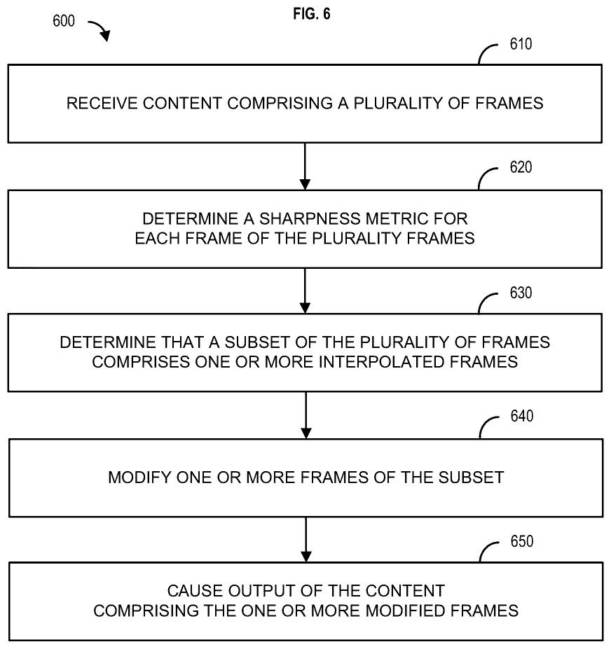

FIG. 6 shows a flowchart of an example method 600. The method 600 may be performed in whole or in part by a single computing device, a plurality of computing devices, and the like. For example, the steps of the method 600 may be performed by the content server 108, the content server 109, and/or a computing device in communication with the content server 108 or the content server 109. Some steps of the method 600 may be performed by a first computing device (e.g., the content server 108), while other steps of the method 600 may be performed by another computing device. For ease of explanation, the method 600 will be described as being performed by the content server 108.

At step 610, the content server 108 may receive content comprising a plurality of frames. Each frame of the plurality of frames may comprise one or more edges. For example, referring to FIGS. 2A-2B, the video frame 200A may comprise a frame edge 201A, while the interpolated video frame 200B may comprise an interpolated frame edge 201B. The content server 108 may determine sharpness metrics for each frame based on the characteristics of the frame edge 201A and the interpolated frame edge 201B. For example, at step 620, the content server 108 may determine a sharpness metric for each frame of the plurality of frames. The sharpness metric may be associated with the one or more edges of each frame. In some cases, a first sharpness metric may be associated with one or more frames of the plurality of frames, and a second sharpness metric may be associated with one or more neighboring frames of the plurality of frames.

Based on the first sharpness metric and the second sharpness metric, the content server 108 may determine that the one or more frames comprise one or more interpolated frames. For example, the content server 108 may plot the sharpness metric for each frame of the plurality of frames, which may exhibit a characteristic sawtooth/zigzag pattern (e.g., similar to the sawtooth sharpness plot 301B). The content server 108 may determine that alternating frames show higher and lower sharpness values in the plot of the sharpness metric for each frame of the plurality of frames. The alternating higher and lower sharpness values in the plot may indicate the presence of interpolated frames, in some examples.

In some cases, a first subset of the plurality of frames may be associated with a first range of sharpness metrics, and a second subset of the plurality of frames may be associated with a second range of sharpness metrics. The content server 108 may compare the sharpness metrics of the first subset and the second subset to identify interpolated frames. For example, at step 630, the content server 108 may determine that the first subset of the plurality of frames comprises one or more interpolated frames. The content server 108 may determine that the first subset comprises the one or more interpolated frames based on the first range of sharpness metrics and the second range of sharpness metrics. For example, the content server 108 may determine that the first subset of the plurality of frames comprises interpolated frames by calculating an average of differences between the sharpness metrics associated with the first subset and the sharpness metrics associated with the second subset. The content server 108 may compare this average of differences to a sharpness threshold. The sharpness threshold may comprise a numerical value. The average of differences may satisfy the sharpness threshold when the average of differences comprises a numerical value that is equal to or less than the sharpness threshold. When the sharpness threshold is satisfied, the content server 108 may the determine that the first subset of the plurality of frames comprises interpolated frames. On the other hand, when the sharpness threshold is not satisfied, the content server 108 may the determine that the first subset of the plurality of frames does not comprise interpolated frames. Other examples are possible as well.

At step 640, the content server 108 may modify one or more frames of the first subset of the plurality of frames. The modification of the one or more frames of the first subset may be based on (e.g., in response to) the first subset comprising the one or more interpolated frames. The content server 108 may modify the one or more frames of the first subset by generating one or more replacement interpolated frames (e.g., to replace the one or more interpolated frames of the first subset). In some cases, the one or more interpolated frames may be associated with a first interpolation method, and the content server 108 may generate the one or more replacement interpolated frames using a second interpolation method. In some cases, the second interpolation method may be associated with a user preference or a user device, such as the user device 112 or 113 of the system 100. For example, the content server 108 may select the second interpolation method based on preferences specified by a user or capabilities of the user device receiving the content.

At step 650, the content server 108 may cause output of the content comprising the one or more modified frames. For example, the content server 108 may cause output of the content comprising the one or more replacement interpolated frames. In some cases, the content server 108 may receive a request for the content from a user device, such as the user device 112 or 113 of the system 100. The content server 108 may receive the request and send the content to the user device excluding the one or more interpolated frames. The user device may then generate the one or more replacement interpolated frames using the second interpolation method. The user device may cause output of the plurality of frames comprising the one or more replacement interpolated frames. Other examples are possible as well.

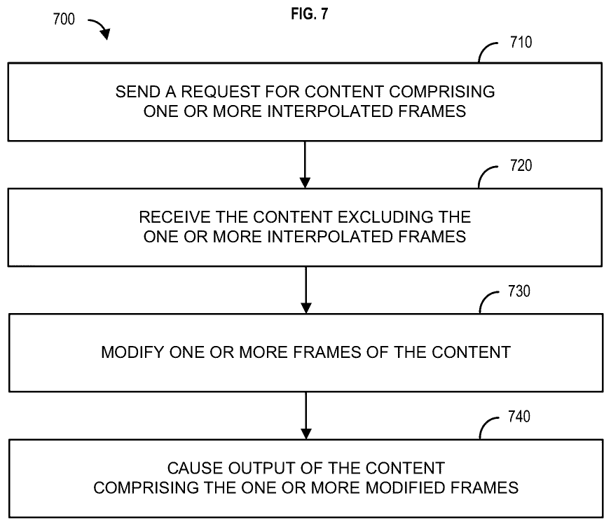

FIG. 7 shows a flowchart of an example method 700. The method 700 may be performed in whole or in part by a single computing device, a plurality of computing devices, and the like. For example, the steps of the method 700 may be performed by the user device 112, the user device 113, and/or a computing device in communication with the user device 112 or the user device 113. Some steps of the method 700 may be performed by a first computing device (e.g., the user device 112), while other steps of the method 700 may be performed by another computing device. For ease of explanation, the method 700 will be described as being performed by the user device 112.

At step 710, the user device 112 may send a request for content. The content may comprise a plurality of frames. The request may indicate a request for the content excluding interpolated frames. For example, the user device 112 may send the request to the content server 108. In some cases, the content server 108 may determine (e.g., before or after receiving the request) a sharpness metric for each frame of the plurality of frames. A first sharpness metric may be associated with one or more frames of the plurality of frames, and a second sharpness metric may be associated with one or more neighboring frames of the plurality of frames. The content server 108 may determine that the one or more frames comprise one or more interpolated frames based on the first sharpness metric and the second sharpness metric. For example, the content server 108 may determine that the one or more frames comprise the one or more interpolated frames by comparing a difference between the first sharpness metric and the second sharpness metric to a sharpness threshold. The content server 108 may remove (e.g., before or after receiving the request) the one or more interpolated frames from the plurality of frames.

At step 720, the user device 112 may receive the content excluding the one or more interpolated frames. For example, the user device 112 may receive the plurality of frames that make up the content with the one or more interpolated frames removed. The one or more interpolated frames may be removed by the content server 108 and/or by another device(s) of the system 100. At step 730, the user device 112 may modify one or more frames of the plurality of frames based on (e.g., in response to) the received content excluding the one or more interpolated frames. The user device 112 may modify the one or more frames by generating one or more replacement interpolated frames (e.g., to replace the one or more interpolated frames). For example, the one or more interpolated frames may be associated with a first interpolation method, and the user device 112 may generate the one or more replacement interpolated frames using a second interpolation method. In some cases, the second interpolation method may be associated with a user preference and/or the user device 112. For example, the user device 112 may select the second interpolation method based on preferences specified by a user or capabilities of the user device 112. Other examples are possible as well. At step 740, the user device 112 may cause output of the content comprising the one or more modified frames. For example, the user device 112 may cause output of the content comprising the one or more replacement interpolated frames.

As mentioned, the method 700 is described above as being performed by the user device 112 for ease of explanation. However, as also mentioned, a computing device in communication with the user device 112 may perform the method 700. For example, the content server 109 may request the content from the content server 108 (e.g., on behalf of the user device 112), and the content server 108 may remove (e.g., before or after receiving the request) the one or more interpolated frames from the plurality of frames prior to sending them to the content server 109. Upon receiving the plurality of frames (excluding the one or more interpolated frames), the content server 109 may generate the one or more replacement interpolated frames and output (or cause output of) the content with the one or more replacement interpolated frames. For example, the content server 109 may store the content with the one or more replacement interpolated frames. Additionally, or in the alternative, the content server 109 may send the content with the one or more replacement interpolated frames to the user device 112 for storage and/or output. Other examples are possible as well.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving, by a first computing device, first content comprising a plurality of frames, wherein each frame of the plurality of frames comprises one or more edges;
determining, for each frame of the plurality of frames, a sharpness metric associated with the one or more edges of the frame, wherein a first sharpness metric is associated with one or more frames of the plurality of frames, and wherein a second sharpness metric is associated with one or more neighboring frames of the plurality of frames;
determining, based on the first sharpness metric and the second sharpness metric, that the one or more frames comprise one or more interpolated frames;
based on the one or more frames comprising the one or more interpolated frames, modifying the one or more frames; and
causing output of the first content comprising the one or more modified frames and the one or more neighboring frames.

2. The method of claim 1, wherein the first sharpness metric substantially differs from the second sharpness metric.

3. The method of claim 1, wherein the one or more interpolated frames are associated with a first interpolation method, and wherein modifying the one or more frames comprises generating, based on a second interpolation method, one or more replacement interpolated frames, wherein the one or more modified frames comprise the one or more replacement interpolated frames.

4. The method of claim 3, wherein the second interpolation method is associated with at least one of: a user preference or a user device.

5. The method of claim 1, wherein each frame, of the plurality of frames, comprises one or more objects, and wherein the one or more objects comprise the one or more edges of that frame.

6. The method of claim 1, wherein causing output of the first content comprises:
receiving, from a user device, a request for the first content; and
sending, to the user device, the first content comprising the one or more modified frames and the one or more neighboring frames.

7. The method of claim 1, wherein determining that the one or more frames comprise the one or more interpolated frames comprises:
determining, based on the first sharpness metric and the second sharpness metric, that a difference between the first sharpness metric and the second sharpness metric satisfies a sharpness threshold; and
determining, based on the difference satisfying the sharpness threshold, that the one or more frames comprise the one or more interpolated frames.

8. A method comprising:
receiving, by a first computing device, first content comprising a plurality of frames, wherein each frame of the plurality of frames comprises one or more edges;
determining, for each frame of the plurality of frames, a sharpness metric associated with the one or more edges of the frame, wherein a first subset of the plurality of frames is associated with a first range of sharpness metrics, and wherein a second subset of the plurality of frames is associated with a second range of sharpness metrics;
determining, based on the first range of sharpness metrics and the second range of sharpness metrics, that the first subset of the plurality of frames comprises one or more interpolated frames;
based on the first subset of the plurality of frames comprising the one or more interpolated frames, modifying one or more frames of the first subset; and
causing output of the first content comprising the one or more modified frames and the second subset of the plurality of frames.

9. The method of claim 8, wherein the first range of sharpness metrics and the second range of sharpness metrics are indicative of a bimodal distribution of frame sharpness across the plurality of frames.

10. The method of claim 8, wherein the first range of sharpness metrics substantially differs from the second range of sharpness metrics.

11. The method of claim 8, wherein the one or more interpolated frames are associated with a first interpolation method, and wherein modifying the one or more frames of the first subset comprises generating, based on a second interpolation method, one or more replacement interpolated frames, wherein the one or more modified frames comprise the one or more replacement interpolated frames.

12. The method of claim 11, wherein the second interpolation method is associated with at least one of: a user preference or a user device.

13. The method of claim 8, wherein each frame, of the plurality of frames, comprises one or more objects, and wherein the one or more objects comprise the one or more edges of that frame.

14. The method of claim 8, wherein determining that the first subset of the plurality of frames comprises the one or more interpolated frames comprises:
determining, based on the first range of sharpness metrics and the second range of sharpness metrics, that an average of differences between sharpness metrics associated with the first subset and sharpness metrics associated with the second subset satisfies a sharpness threshold; and
determining, based on the average of differences satisfying the sharpness threshold, that the first subset of the plurality of frames comprises the one or more interpolated frames.

15. A method comprising:
sending, by a first computing device, a request for first content comprising a plurality of frames, wherein the plurality of frames comprises one or more interpolated frames;
receiving, based on the request, the plurality of frames excluding the one or more interpolated frames;
based on the plurality of frames excluding the one or more interpolated frames, modifying one or more frames of the plurality of frames; and
causing output of the first content comprising the one or more modified frames.

16. The method of claim 15, wherein the one or more interpolated frames are associated with a first interpolation method, and wherein modifying the one or more frames comprises generating, based on a second interpolation method, one or more replacement interpolated frames, wherein the one or more modified frames comprise the one or more replacement interpolated frames.

17. The method of claim 16, wherein a first sharpness metric associated with the one or more interpolated frames and the first interpolation method is less than a second sharpness metric associated with the one or more replacement interpolated frames and the second interpolation method.

18. The method of claim 15, further comprising:
determining, by a second computing device, for each frame of the plurality of frames, a sharpness metric, wherein a first sharpness metric is associated with the one or more frames of the plurality of frames, and wherein a second sharpness metric is associated with one or more neighboring frames of the plurality of frames;
determining, based on the first sharpness metric and the second sharpness metric, that the
one or more frames comprise the one or more interpolated frames; and
removing, based on the one or more frames comprising the one or more interpolated frames, the one or more interpolated frames from the plurality of frames.

19. The method of claim 15, further comprising:
determining, by a second computing device, for each frame of the plurality of frames, a sharpness metric, wherein a first subset of the plurality of frames is associated with a first range of sharpness metrics, and wherein a second subset of the plurality of frames is associated with a second range of sharpness metrics;
determining, based on the first range of sharpness metrics and the second range of sharpness metrics, that the first subset of the plurality of frames comprises the one or more interpolated frames; and
removing, based on the one or more frames comprising the one or more interpolated frames, the one or more interpolated frames from the plurality of frames.

20. The method of claim 19, wherein the first range of sharpness metrics substantially differs from the second range of sharpness metrics.
